(19) United States
(12) Patent Application Publication
(10) Pub. No.: US 2017/0344822 A1
(43) Pub. Date: Nov. 30, 2017

(54) SEMANTIC REPRESENTATION OF THE CONTENT OF AN IMAGE

(71) Applicant: COMMISSARIAT A L'ENERGIE ATOMIQUE ET AUX ENERGIES ALTERNATIVES, PARIS (FR)

(72) Inventors: Adrian POPESCU, MONTROUGE (FR); Nicolas BALLAS, GIF SUR YVETTE (FR); Alexandru Lucian GINSCA, MONTROUGE (FR); Hervé LE BORGNE, PARIS (FR)

(21) Appl. No.: 15/534,941

(22) PCT Filed: Dec. 1, 2015
(86) PCT No.: PCT/EP2015/078125

§ 371 Date: Jun. 9, 2017

(30) Foreign Application Priority Data
Dec. 23, 2014 (FR) 1463237

(51) Int. Cl. G06K 9/00; G06F 17/30; G06K 9/72; G06N 99/00

(52) U.S. Cl. CPC G06K 9/00456; G06N 99/005; G06F 17/30256; G06F 17/30271; G06K 9/726

(57) ABSTRACT

A method implemented by computer for the semantic description of the content of an image comprising the steps consisting in receiving a signature associated with the image; receiving a plurality of groups of initial visual concepts; the method comprising the steps of expressing the signature of the image in the form of a vector comprising components referring to the groups of initial visual concepts; and modifying the signature by applying a filtering rule applicable to the components of the vector. Developments describe, in particular, intra-group or inter-group, thresholds-based and/or order-statistic-based filtering rules, partitioning techniques including the visual similarity of the images and/or semantic similarity of the concepts, the optional addition of manual annotations to the semantic description of the image. The advantages of the method in respect of parsimonious and diversified semantic representation are presented.

### FIELD OF THE INVENTION

The invention relates in general to the technical field of data mining and in particular to the technical field of the automatic annotation of the content of an image.

### PRIOR ART

A “multimedia” document comprises—by etymology—information of various kinds, generally associated with distinct sensory or cognitive capacities (for example with vision or with hearing). A multimedia document may be for example an image accompanied by “tags”, that is to say by annotations or else correspond a Web page comprising images and text.

A digital document may generally be divided into several information “channels”, which may include for example textual information (originating from OCR character recognition for example) and visual information (such as illustrations and/or photos identified in the document). A video too may also be separated into several of such channels: a visual channel (e.g. the frames of the video), a sound channel (e.g. the soundtrack), a text channel (e.g. resulting from the transcription of the speech into text, as well as the metadata of the video, for example date, author, title, format, etc.). A multimedia document may therefore contain, in particular, visual information (i.e. pixels) and textual information (i.e. words).

When mining in multimedia data, the process of querying (i.e. for searching through databases) may involve queries which may themselves take on various forms: (a) one or more multimedia documents (combining images and texts), and/or (b) in the form of visual information alone (searching termed “image based searching” or “image content based searching”) or else (c) in text form alone (general case of mass-market search engines).

The technical problem of information searching within multimedia databases consists in particular in retrieving the documents from the base that resemble the query to the greatest possible extent. In an annotated database (for example employing labels and/or tags), a technical problem posed by classification consists in predicting this or these labels for a new non-annotated document.

The content of an exclusively visual document must be associated with classification models which determine the classes with which the document may be associated, for example in the absence of tags or of annotations or of description based on key words of the image (or indirectly via the context of publication of the image for example). In the case where these metadata are accessible, the content of a multimedia document (combining image and text) must be described in a consistent and effective manner.

An initial technical problem therefore consists in determining an effective way of determining the visual content of an image, that is to say of constructing a semantic representation of the latter. If textual annotations exist, this will entail for example combining the representation of the visual content with these annotations.

The relevance of the representation thus constructed may be effected in multiple ways, one of which being, in particular, the measurement of the accuracy of the results. In respect of image searching, the accuracy is given by the number of images semantically similar to an image query, text query or an image and text combination query. In respect of image classification, the relevance is evaluated by the accuracy of the results (e.g. proportion of correctly predicted labels) and its capacity for generalization (e.g. classification “works” for several classes to be recognized). The calculation time (generally determined by the complexity of the representation) is generally a significant factor in these two search and classification scenarios.

The availability of broad collections of images that are structured (for example according to concepts, such as ImageNet (Deng et al., 2009), together with the availability of training procedures (which exhibit sufficient possibilities for scaling) has led to the proposal for semantic representations of visual content (cf. Li et al., 2010; Su and Jurie, 2012; Bergamo and Torresani, 2012). These representations are generally implemented by starting from one or more basic visual descriptors (i.e. local or global or according to a combination of the two). Thereafter, these descriptions are used by training procedures to construct classifiers or descriptors for individual concepts. A classifier or descriptor assigns or allocates one or more classes (e.g. name, quality, property, etc) to an object, or associates one or more such classes with an object, here an image. Finally, the final description is obtained by aggregating the probability scores given by the classification of the test images against each classifier associated with the concepts which make up the representation (Torresani et al., 2010). On their side, Li et al., in 2010 introduced ObjectBank, a semantic representation made up of the responses of approximately 200 classifiers precalculated with the help of a manually validated base of images. In 2012, Su and Jurie manually selected 110 attributes to implement a semantic representation of images. In 2010, Torresani et al. introduced “classemes”, which are based on more than 2000 models of individual concepts trained using images from the Web. Subsequent to this work, Bergamo and Torresani introduced in 2012 “meta-classes”, i.e. representations founded on concepts originating from ImageNet in which similar concepts are grouped together and trained jointly. In 2013, deep neural networks were used to solve large-scale image classification problems (Sermanet et al.; Donahue et al.) According to this approach, the classification scores given by the last layer of the network are usable as semantic representation of the content of an image. However, several hardware limitations mean that it is difficult to effectively represent a large number of classes and a very large number of images within one and the same network. The number of classes processed is typically of the order of 1000 and the number of images of the order of a million.

In 2012, Bergamo and Torresani published an article entitled “Meta-class features for large-scale object categorization on a budget” (CVPR. IEEE, 2012). The authors propose a compact representation of images by grouping together concepts of the ImageNet hierarchy by using their visual affinity. The authors use a quantization (i.e. the most salient dimensions are set to 1 and the others to 0) thereby rendering the descriptor more compact. Nonetheless, this approach defining “meta classes” does not make it possible to ensure diversified representation of the content of the images. Moreover, quantization also gives rise to diminished performance.

Aspects relating to the diversity of image searching are tackled fairly rarely by the current state of the art. Diversity implies that various concepts present in an image appear in the associated representation.

The invention proposed in the present document makes it possible to address these needs or limitations, at least in part.

### SUMMARY OF THE INVENTION

There is disclosed a method implemented by computer for the semantic description of the content of an image comprising the steps consisting in receiving a signature associated with said image; receiving a plurality of groups of initial visual concepts; the method being characterized by the steps consisting in expressing the signature of the image in the form of a vector comprising components referring to the groups of initial visual concepts; and modifying said signature by applying a filtering rule applicable to the components of said vector. Developments describe, in particular, intra-group or inter-group, thresholds-based and/or order-statistic-based filtering rules, partitioning techniques including the visual similarity of the images and/or semantic similarity of the concepts, the optional addition of manual annotations to the semantic description of the image. The advantages of the method in respect of parsimonious and diversified semantic representation are presented.

The method according to the invention will advantageously find application within the framework of multimedia information searching and/or classification of documents (for example in a data mining context).

According to one aspect of the invention, the visual documents are represented by the probabilities obtained by comparing these documents with individual concept classifiers.

According to one aspect of the invention, a diversified representation of the content of the images is allowed.

According to one aspect of the invention, the compact character of the representations is ensured without loss of performance.

Advantageously, an embodiment of the invention proposes a semantic representation which is both compact and diversified.

Advantageously, the invention proposes semantic representations of visual content which associate diversity and sparse character, two aspects which are not currently tackled in the literature in the field. Diversity is significant because it guarantees that various concepts present in the image appear in the representation. The sparse character is significant since it makes it possible to accelerate the process of similarity-based image searching by means of inverted files.

Advantageously, the invention ensures a capacity for generalization of the semantic representation (i.e. the system may operate independently of the content itself).

Advantageously, the method according to the invention is generally fast to calculate and to use for massive multimedia databases.

Advantageously, the method according to the invention allows semantic representations which are both diversified and sparse.

The invention will advantageously find application in respect of any task which requires the description of a multimedia document (combining visual and textual information) with a view to searching for or classifying this document. For example, the method allows the implementation of multimedia search engines; the exploration of “massive” multimedia stashes is generally considerably accelerated because of the sparse character of the semantic representation of the method. The invention allows the large-scale recognition of objects present in an image or in a video. It will for example be possible, with a view to proposing contextual advertisements, to create user profiles with the help of their images and to use these profiles to target or personalize advertisements.

### DESCRIPTION OF THE FIGURES

Various aspects and advantages of the invention will become apparent in support of the description of a preferred but nonlimiting mode of implementation of the invention, with reference to the figures hereinbelow:

FIG. 1 illustrates the classification or the annotation of a document;

FIG. 2 illustrates an example of supervised classification;

FIG. 3 illustrates the overall diagram of an exemplary method according to the invention;

FIG. 4 details certain steps specific to the method according to the invention.

### DETAILED DESCRIPTION OF THE INVENTION

FIG. 1 illustrates the classification or annotation of a document. In the example considered, the document is an image 100. The labels 130 of this document indicate its degree of membership in each of the classes 110 considered. By considering for example four classes (here “wood”, “metal”, “earth” and “cement”), the label 120 annotating the document 100 is a vector 140 with 4 dimensions, each component of which is a probability (equal to 0 if the document does not correspond to the class, and equal to 1 if the document corresponds thereto in a definite manner).

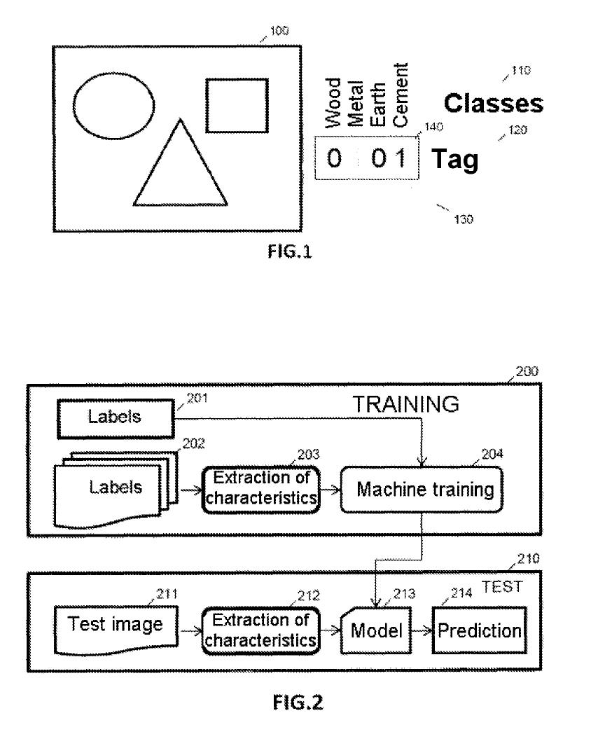

FIG. 2 illustrates an example of supervised classification. The method comprises in particular two steps: a first so-called training step 200 and a second so-called test step 210. The training step 200 is generally performed “off-line” (that is to say in a prior manner or else carried out in advance). The second step 210 is generally performed “on-line” (that is to say in real time during the actual search and/or classification steps).

Each of these steps 200 and 210 comprises a step of representation based on characteristics (or “feature extraction”, step 203 and 212) which makes it possible to describe a document by a vector of fixed dimension. This vector is generally extracted from one of the modalities (i.e. channel) of the document only. The visual characteristics include the local representations (i.e. visual word bags, Fisher vectors etc.) or global representations (histograms of colors, descriptions of textures etc.) of the visual content or of the semantic representations.

The semantic representations are generally obtained through the use of intermediate classifiers which provide values of probability of appearance of an individual concept in the image and include the classemes or the meta-classes. In a schematic manner, a visual document will be represented by a vector of the type {“dog”=0.8, “cat”=0.03, “car”=0.03, . . . , “sunny”=0.65}.

During the training phase 200, a series of such vectors and the corresponding labels 202 feed a training module (“machine learning” 204) which thus produces a model 213. In the test phase 210, a “test” multimedia document 211 is described by a vector of the same kind as during the training 200. The latter is used as input to the previously trained model 213. A prediction 214 of the label of the test document 211 is returned as output.

The training implemented in step 204 may comprise the use of various techniques, considered alone or in combination, in particular of “separators with vast margin” (SVM), of the training method called “boosting”, or else of the use of neural networks, for example “deep” neural networks.

According to a specific aspect of the invention, there is disclosed a step of extracting advantageous characteristics (steps 203 and 212). In particular, the semantic descriptor considered involves a set of classifiers (“bank”).

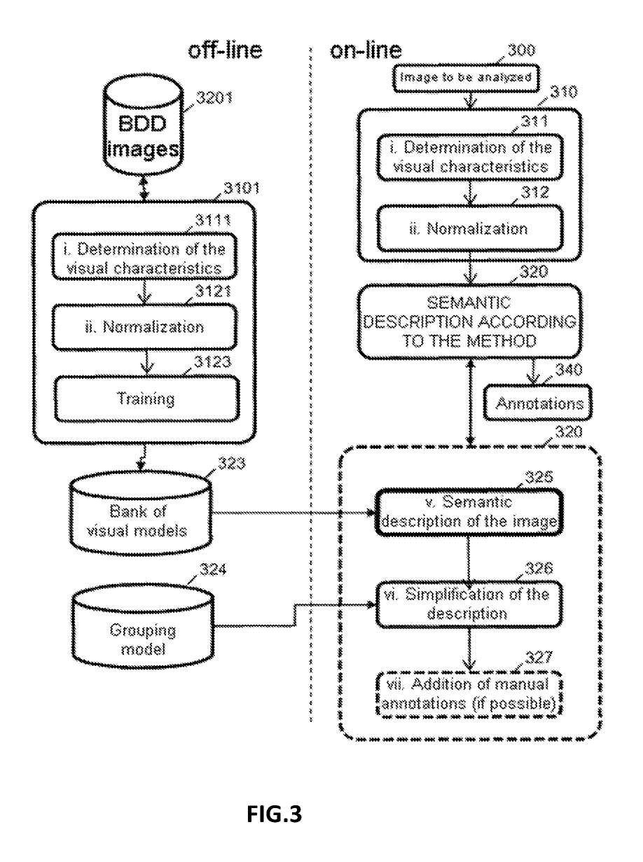

FIG. 3 illustrates the overall diagram of an exemplary method according to the invention. The figure illustrates an example of constructing a semantic representation associated with a given image.

The figure illustrates “on-line” (or “active”) steps. These steps designate steps which are performed substantially at the time of image search or annotation. The figure also illustrates “off-line” (or “passive”) steps. These steps are generally performed beforehand, i.e. prior (at least in part).

In a prior or “off-line” manner, the set of images of a database provided 3201 may be analyzed (the method according to the invention may also proceed by accumulation and construct the database progressively and/or the groupings by iteration). Steps of extracting the visual characteristics 3111 and of normalization 3121 are repeated for each of the images constituting said database of images 3201 (the latter is structured as n concepts C). One or more (optional) training steps 3123 may be performed (positive and/or negative examples, etc). Together, these operations may serve moreover to determine or optimize the establishment of the visual models 323 (cf. hereinafter) as well as of the grouping models 324.

In step 323, there is received a bank of visual models. This bank of models may be determined in various ways. In particular, the bank of models may be received from a third party module or system, for example subsequent to step 3101. A “bank” corresponds to a plurality of visual models V (termed “individual visual models”). An “individual visual model” is associated with each of the initial concepts (“sunset”, “dog”, etc) of the reference base. The images associated with a given concept represent positive examples for each concept (while the negative examples—which are for example chosen by sampling—are associated with the images which represent the other concepts of the training base).

In step 324, the (initial, i.e. as received) concepts are grouped. Models of groupings are received (for example from third party systems).

Generally, according to the method of the invention, an image to be analyzed 300 is submitted/received and forms the subject of various processings and analyses 310 (which may sometimes be optional) and then a semantic description 320 of this image is determined by the method according to the invention. One or more annotations 340 are determined as output.

In the detail of step 310, in a first step 311 (i), the visual characteristics of the image 300 are determined. The base 3201 (which generally comprises thousands of images or indeed millions of images) is—initially i.e. beforehand—structured as n concepts C (in certain embodiments, for certain applications, n may be of the order of 10 000). The visual characteristics of the image are determined in step 311 (but they may also be received from a third party module; for example, they may be provided as metadata). Step 311 is generally the same as step 3111. The content of the image 300 is thus represented by a vector of fixed size (or “signature”). In a second step 312 (ii), the visual characteristics of the image 300 are normalized (if appropriate, that is to say if necessary; it may happen that some visual characteristics received are already normalized).

In the detail of step 320 (semantic description of the content of the image according to the method), in step 325 (v) according to the invention, there is determined a semantic description of each image. In step 326 (vi), according to the invention, this semantic description may be “pruned” (or “simplified” or “reduced”), for one or for several images. In an optional step 327 (vii), annotations of diverse provenances (including manual annotations) may be added or utilized.

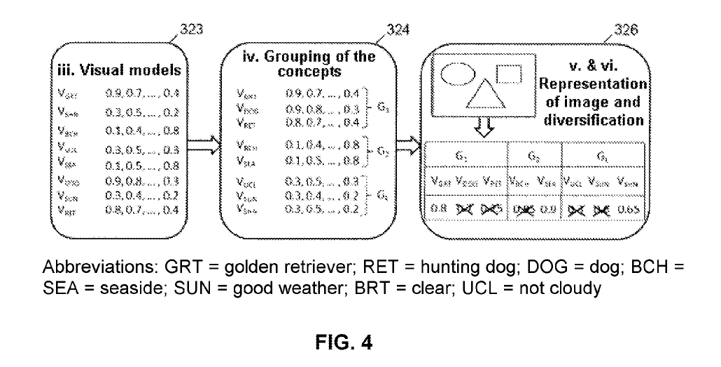

FIG. 4 explains in detail certain steps specific to the method according to the invention. Steps v, vi and optionally vii (taken in combination with the other steps described presently) correspond to the specific features of the method according to the invention. These steps make it possible in particular to obtain a diversified and parsimonious representation of the images of a database.

A “diversified” representation is allowed by the use of groups—instead of the initial individual concepts such as provided by the originally annotated database—which advantageously makes it possible to represent a greater diversity of aspects of the images. For example, a group will be able to contain various breeds of dogs and various levels of granularity of these concepts (“golden retriever”, “labrador retriever”, “border collie”, “retriever” etc.). Another group will be able to be associated with a natural concept (for example related to seaside scenes), another group will relate to meteorology (“good weather”, “cloudy”, “stormy”, etc).

A “sparse” representation of the images corresponds to a representation containing a reduced number of non-zero dimensions in the vectors (or signatures of images). This parsimonious (or “sparse”) character allows effective searching in databases of images even on a large scale (the signatures of the images are compared, for example with one another, generally in random-access memory; an index of these signatures, by means of inverted files for example, makes it possible to accelerate the process of similarity-based image searching).

The two characters of “diversified representation” and of “parsimony” operate in synergy or in concert: the diversified representation according to the invention is compatible (e.g. allowed or facilitated) with parsimonious searching; parsimonious searching advantageously exploits a diversified representation.

In step 324, the concepts are grouped so as to obtain k groups Gₓ, with x=1, . . . k and k<n.

Gₓ={Vₓ₁, Vₓ₂, . . . , V_{xy}} (1)

Various procedures (optionally combined together) may be used for the segmentation into groups. This segmentation may be static and/or dynamic and/or configured and/or configurable.

In certain embodiments, the groupings may in particular be based on the visual similarity of the images. In other embodiments, the visual similarity of the images is not necessarily taken into account.

In one embodiment, the grouping of the concepts may be performed as a function of the semantic similarity of the images (e.g. as a function of the accessible annotations). In one embodiment, the grouping of the concepts is supervised, i.e. benefits from human cognitive expertise. In other embodiments, the grouping is non-supervised. In one embodiment, the grouping of the concepts may be performed using a “clustering” procedure such as K-means (or K-medoids) applied to each image's characteristic vectors trained on a training base. This results in mean characteristic vectors of clusters. This embodiment allows, in particular, minimum human intervention upstream (only the parameter K has to be chosen). In other embodiments, the user's intervention in respect of grouping is excluded (for example by using a clustering procedure such as “shared nearest neighbor” which makes it possible to dispense with any human intervention).

In other embodiments, the grouping is performed according to hierarchical grouping procedures and/or expectation maximization (EM) algorithms and/or density-based algorithms such as DBSCAN or OPTICS and/or connexionist procedures such as self-adaptive maps.

Each group corresponds to a possible (conceptual) “aspect” able to represent an image. Various consequences or advantages ensue from the multiplicity of possible ways to undertake the groupings (number of groups and size of each group, i.e. number of images within a group). The size of a group may be variable so as to address application needs relating to a variable granularity of the representation. The number of groups may correspond to partitions that are more fine or less fine (more coarse or less coarse) than the initial concepts (such as inherited or accessed in the original annotated image base).

The segmentation into groups of appropriate sizes makes it possible in particular to characterize (more or less finely, i.e. according to various granularities) various conceptual domains. Each group may correspond to a “meta concept” which is for example coarser (or broader) than the initial concepts. The step consisting in segmenting or partitioning the conceptual space culminates advantageously in the creation (ex nihilo) of “meta concepts”. Stated otherwise, the set of these groups (or “meta-concepts”) form a new partition of the conceptual representation space in which the images are represented.

In step 325 according to the invention, for every test image, one or more visual characteristics is or are calculated or determined and are normalized (steps i and ii) and compared with the visual models of the concepts (step iii) so as to obtain a semantic description D of this image based on the probability of occurrence p(V_{xy}) (with 0≦p(V_{xy})≦1) of the elements of the bank of concepts.

The description of an image is therefore structured according to the groups of concepts calculated in iv:

$$\underbrace{D = \{ \{ p ( {V}_{11} ) , p ( {V}_{12} ) ,}_{{G}_{1}} … , \underbrace{p ( {V}_{1 a} ) \} , \{ p ( {V}_{21} ) , p ( {V}_{22} ) ,}_{{G}_{2}} {…}_{…} , \underbrace{p ( {V}_{2 b} ) \} , … , \{ p ( {V}_{k 1} ) , p ( {V}_{k2 } ) ,}_{{G}_{k}} … , p ( {V}_{kc} ) \} \} \qquad ( 2 )$$

The number of groups retained may in particular vary as a function of the application needs. In a parsimonious representation, a small number of groups is used, thereby increasing the diversification but conversely decreasing the expressivity of the representation. Conversely, without groups, expressivity is maximal but the diversity is decreased since one and the same concept will be present at several levels of granularity (“golden retriever”, “retriever” and “dog” in the example cited hereinabove). Subsequent to the grouping operation, the three previous concepts will lie within one and the same group, which will be represented by a single value. Therefore there is therefore proposed a representation based on “intermediate groups”, which makes it possible to integrate diversity and expressivity simultaneously.

In the sixth step 326 (vi) according to the invention, the description D obtained is pruned or simplified so as to keep, within each group Gₓ, only the highest probability or probabilities p(V_{xy}) and to eliminate the low probabilities (which may have a negative influence when calculating the similarity of the images).

In one embodiment, each group is associated with a threshold (optionally different) and the probabilities (which are for example below) these thresholds are eliminated. In one embodiment, all the groups are associated with one and the same threshold making it possible to filter the probabilities. In one embodiment, one or more groups are associated with one or more predefined thresholds and the probabilities which are above and/or below these thresholds (or ranges of thresholds) may be eliminated.

A threshold may be determined in various ways (i.e. according to various types of mathematical average according to other types of mathematical operators). A threshold may also be the result of a predefined algorithm. Generally, a threshold may be static (i.e. invariant in the course of time) or else dynamic (e.g. dependent on one or more exterior factors, such as for example controlled by the user and/or originating from another system). A threshold may be configured (e.g. in a prior manner, that is to say “hard-coded”) but it may also be configurable (e.g. according to the type of search, etc).

In one embodiment, a threshold does not relate to a probability value (e.g. a score) but to a number Kp(Gx), associated with the rank (after sorting) of the probability to “preserve” or to “eliminate” a group Gx. According to this embodiment, the probability values are ordered i.e. ranked by value and then a determined number Kp(Gx) of probability values are selected (as a function of their ordering or order or rank) and various filtering rules may be applied. For example, if Kp(Gx) is equal to 3, the method may preserve the 3 “largest” values (or the 3 “smallest”, or else 3 values “distributed around the median”, etc). A rule may be a function (max, min, etc).

For example, considering a group 1 comprising {P(V11)=0.9; P(V12)=0.1; P(V13)=0.8} and a group 2 comprising {P(V21)=0.9; P(V22)=0.2; P(V23)=0.4}, the application of a filtering based on a threshold equal to 0.5 will lead to the selecting of P(V11) and P(V13) for group 1 and P(V21) for group 2. By applying with Kp(Gx)=2 a filtering rule “keep the largest values”, P(V11) and P(V13) will be kept for group 1 (same result as procedure 1) but P(V21) and P(V23) will be kept for group 2.

The pruned version of the semantic description Dₑ may then be written as (in this case Kp(Gx) would equal 1):

Dₑ={{p(V₁₁), 0, . . . , 0}, {0, p(V₂₂), . . . , 0}, . . . , {0, 0, . . . , p(V_{kc})}} (3)

with: p(V₁₁)>p(V₁₂), p(V₁₁)>p(V₁ₐ) for G₁; p(V₂₂)>p(V_{1b}), p(V₂₂)>p(V_{1b}), for G₂ and p(V_{kc})>p(Vₖ₁), p(V_{kc})>p(Vₖ₂) for Gₖ.

The representation given in (3) illustrates the use of a procedure for selecting dimensions termed “max-pooling”. This representation is illustrative and the use of said procedure is entirely optional. Other alternative procedures may be used in place of “max pooling”, such as for example the technique termed “average pooling” (mean of the probabilities of the concepts in each group Gₖ) or else the technique termed “soft max pooling” (average of the x highest probabilities within each group).

The score of the groups will be denoted s(Gₖ) hereinafter.

The pruning described in formula (3) is intra-group. A last inter-group pruning is advantageous so as to arrive at a “sparse” representation of the image.

More precisely, starting from Dₑ={s(G₁), s(G₂), . . . , s(Gₖ)} and after applying the intra-group pruning described in (3), only the groups having the highest scores are retained. For example, assuming that a description with just two non-zero dimensions is desired, and that s(G₁)>s(Gₖ₂)>. . . >s(G₂), then the final representation will be given by:

D_{f}={s(G₁), 0, . . . , s(Gₖ)} (4)

The selection of one or more concepts in each group makes it possible to obtain a “diversified” description of the images, that is to say one which includes various (conceptual) aspects of the image. Recall that an “aspect” or “meta aspect” of the conceptual space corresponds to a group of concepts that are chosen from among the initial concepts.

The advantage of the method proposed in this invention is that it “forces” the representation of an initial image on or to one or more of these aspects (or “meta concepts”), even if one of these aspects is initially predominant. For example, if an image is chiefly annotated by the concepts associated with “dog”, “golden retriever” and “hunting dog” but also, to a lesser extent, by the concepts “car” and “lamppost”, and if step iv of the proposed method culminates in the formation of three meta-concepts (i.e. groups/aspects, etc.) containing {“dog”+“golden retriever”+“hunting dog”} for the first group, {“car”+“bike”+“motorcycle”} for the second group and {“lamppost”+“town”+“street”} for the third group, then a semantic representation according to the prior art will place most of its weighting on the concepts “dog”, “golden retriever” and “hunting dog”, while the method according to the invention will make it possible to identify that these four concepts describe a similar aspect and will allot—also—some weight to the “car” and “lamppost” membership aspect thus making it possible to retrieve in a more accurate manner images of dogs taken in town, outdoors, in the presence of transport means.

Advantageously, in the case, such as proposed by the method according to the invention, of a large initial number of concepts and of a “sparse” representation, the representation according to the method according to the invention allows better comparability of the dimensions of the description. Thus, without groups, an image represented by “golden retriever” and another represented by “retriever” will have a similarity equal to or close to zero on account of the presence of these concepts. With the groupings according to the invention, the presence of the two concepts will contribute to increasing the (conceptual) similarity of the images on account of their common membership of a group.

From the point of the user experience, the image-content-based searching according to the invention advantageously makes it possible to take into account more aspects of the query (and not only the concept or concepts that are “dominant” according to the image based searching known in the prior art). The “diversification” resulting from the method is particularly advantageous. It is nonexistent in the current image descriptors. By fixing the size of the groups at the limit value equal to 1, a diversification-free method of semantic representation of images is obtained.

In a step 322 (vii), if there exist textual annotations associated with the image which are appended manually (generally of high semantic quality), the associated concepts are added to the semantic description of the image with a probability 1 (or at least greater than the probabilities associated with the tasks of automatic classification for example). This step remains entirely optional since it depends on the existence of manual annotations which might not be available).

In one embodiment, the method according to the invention performs groupings of images in a unique manner (stated otherwise, there exist N groups of M images). In one embodiment, “collections” i.e. “sets” of groups of different sizes are precalculated (stated otherwise, there exist A groups of B images, C groups of D images, etc). The image-content-based search may be “parametrized”, for example according to one or more options presented to the user. If appropriate, one or the other of the precalculated collections is activated (i.e. the search is performed within the determined collection). In certain embodiments, the calculation of the various collections is performed in the background of the searches. In certain embodiments, the selection of one or more collections is (at least in part) determined as a function of user feedback.

Generally, the methods and systems according to the invention relate to the annotation or the classification or the automatic description of the image content considered as such (i.e. without necessarily taking into consideration data sources other than the content of the image or the associated metadata). The automatic approach disclosed by the invention may be supplemented or combined with associated contextual data of the images (for example related to the modalities of publication or visual rendition of these images). In a variant embodiment, the contextual information (for example the key words arising from the Web page on which the image considered is published or else the context of rendition if it is known) may be used. This information may for example serve to corroborate, bring about or inhibit or confirm or deny the annotations extracted from the analysis of the content of the image according to the invention. Various tailoring mechanisms may indeed be combined with the invention (filters, weighting, selection, etc). The contextual annotations may be filtered and/or selected and then added to the semantic description (with suitable confidence probabilities or factors or coefficients or weightings or intervals for example).

Embodiments of the invention are described hereinafter.

There is described a method implemented by computer for the semantic description of the content of an image comprising the steps consisting in: receiving a signature associated with said image; receiving a plurality of groups of initial visual concepts; the method being characterized by the steps consisting in: expressing the signature of the image in the form of a vector comprising components referring to the groups of initial visual concepts; and modifying said signature by applying a filtering rule applicable to the components of said vector.

The signature associated with the image, i.e. the initial vector, is generally received (for example from another system). This signature is for example obtained after the extraction of the visual characteristics of the content of the image, for example by means of predefined classifiers known from the prior art, and of diverse other processings, normalization processing in particular. The signature may be received in the form of a vector expressed in a different frame of reference. The method “expresses” or transforms (or converts or translates) the vector received in the appropriate work frame of reference. The signature of the image is therefore a vector (comprising components) of a constant size of size C.

An initially annotated base also provides a set of initial concepts, for example in the form of (textual) annotations. These groups of concepts may in particular be received in the form of “banks”. The signature is then expressed with references to groups of “initial visual concepts” (textual objects) i.e. such as received. The references to the groups are therefore components of the vector. The matching of the components of the vector with the groups of concepts is performed. The method according to the invention manipulates i.e. partitions the initial visual concepts according to Gₓ={Vₓ₁, Vₓ₂, . . . , V_{xy}}, with x=1, . . . k and k<n. and creates a new signature of the image.

The method thereafter determines a semantic description of the content of the image by modifying the initial signature of the image, i.e. by preserving or by canceling (e.g. setting to zero) one or more components (references to the groups) of the vector. The modified vector is still of size C. Various filtering rules may be applied.

In a development, the filtering rule comprises holding or setting to zero one or more components of the vector corresponding to the groups of initial visual concepts by applying one or more thresholds.

The semantic description may be modified in an intra-group manner by applying thresholds, said thresholds being selected from among mathematical operators comprising for example mathematical averages.

The pruning may be intra-group (e.g. selection of the dimensions termed “max-pooling” or “average pooling” (average of the probabilities of the concepts in each group Gₖ) or else according to the technique termed “soft max pooling” (average of the x highest probabilities within each group).

In a development, the filtering rule comprises holding or setting to zero one or more components of the vector corresponding to the groups of initial visual concepts by applying an order statistic.

In statistics, the order statistic of rank k of a statistical sample is equal to the k-th smallest value. Associated with the rank statistics, the order statistic forms part of the fundamental tools of non-parametric statistics and of statistical inference. The order statistic comprises the statistics of the minimum, of the maximum, of the median of the sample as well as the various quantiles, etc.

Filters (designation and then action) based on thresholds and order statistic rules may be combined (it is possible to act on the groups of concepts—in the guise of components—with thresholds alone or order statistics alone or both).

For example, the semantic description determined may be modified in an intragroup groups manner by applying a predefined rule of filtering of a number Kp(Gx) of values of probabilities of occurrence of an initial concept within each group.

In each group, a) the values of probabilities (of occurrence of an initial concept) are ordered; b) a number Kp(Gx) is determined; and c) a predefined filtering rule is applied (this rule is chosen from among the group comprising in particular the rules “selection of the Kp(Gx) maximum values”, “selection of the Kp(Gx) minimum values”, “selection of the Kp(Gx) values around the median”, etc, etc.). Finally the semantic description of the image is modified by means of the probability values thus determined.

In a development, the method furthermore comprises a step consisting in determining a selection of groups of initial visual concepts and a step consisting in setting to zero the components corresponding to the groups of visual concepts selected (several components or all).

This development corresponds to an inter-group filtering.

In a development, the segmentation into groups of initial visual concepts is based on the visual similarity of the images.

The training may be non-supervised; step 324 provides such groups based on visual similarity.

In a development, the segmentation into groups of initial visual concepts is based on the semantic similarity of the concepts.

In a development, the segmentation into groups of initial visual concepts is performed by one or more operations chosen from among the use of K-means and/or of hierarchical groupings and/or of expectation maximization (EM) and/or of density-based algorithms and/or of connexionist algorithms.

In a development, at least one threshold is configurable.

In a development, the method furthermore comprises a step consisting in receiving and in adding to the semantic description of the content of the image one or more textual annotations of manual source.

In a development, the method furthermore comprises a step consisting in receiving at least one parameter associated with an image content based search query, said parameter determining one or more groups of visual concepts and a step consisting in undertaking the search within the groups of concepts determined.

In a development, the method furthermore comprises a step consisting in constructing collections of groups of initial visual concepts, a step consisting in receiving at least one parameter associated with an image content based search query, said parameter determining one or more collections from among the collections of groups of initial visual concepts and a step consisting in undertaking the search within the collections determined.

In this development, the “groups of groups” are addressed. In one embodiment, it is possible to choose (e.g. characteristics of the query) from among various precalculated partitions (i.e. according to different groupings). In a very particular embodiment, the partition may (although with difficulty) be done in real time (i.e. at the time of querying).

There is disclosed a computer program product, said computer program comprising code instructions making it possible to perform one or more of the steps of the method.

There is also disclosed a system for the implementation of the method according to one or more of the steps of the method.

The present invention may be implemented with the help of hardware elements and/or software elements. It may be available as a computer program product on a computer readable medium. The medium may be electronic, magnetic, optical or electromagnetic. The device implementing one or more of the steps of the method may use one or more dedicated electronic circuits or a general-purpose circuit. The technique of the invention may be carried out on a reprogrammable calculation machine (a processor or a micro-controller for example) executing a program comprising a sequence of instructions, or on a dedicated calculation machine (for example a set of logic gates such as an FPGA or an ASIC, or any other hardware module). A dedicated circuit may in particular accelerate performance in respect of extraction of characteristics of the images (or of collections of images or “frames” of videos). By way of exemplary hardware architecture suitable for implementing the invention, a device may comprise a communication bus to which are linked a Central Processing Unit (CPU) or microprocessor, which processor may be “multi-core” or “many-core”; a Read-Only Memory (ROM) able to comprise the programs necessary for the implementation of the invention; a cache memory or Random-Access Memory (RAM) comprising registers suitable for recording variables and parameters created and modified in the course of the execution of the aforementioned programs; and a communication interface or I/O (“Input/Output”) suitable for transmitting and receiving data (e.g. images or videos). In particular, the random-access memory may allow fast comparison of the images by way of the associated vectors. In the case where the invention is installed on a reprogrammable calculation machine, the corresponding program (that is to say the sequence of instructions) may be stored in or on a removable storage medium (for example a flash memory, an SD card, a DVD or Bluray, a mass storage means such as a hard disk e.g. an SSD) or a non-removable, volatile or non-volatile storage medium, this storage medium being readable partially or totally by a computer or a processor. The computer readable medium may be transportable or communicatable or mobile or transmissible (i.e. by a telecommunication network: 2G, 3G, 4G, Wifi, BLE, optical fiber or other). The reference to a computer program which, when it is executed, performs any one of the functions described previously, is not limited to an application program executing on a single host computer. On the contrary, the terms computer program and software are used here in a general sense to refer to any type of computerized code (for example, an application software package, micro software, a microcode, or any other form of computer instruction) which may be used to program one or more processors to implement aspects of the techniques described here. The computerized means or resources may in particular be distributed (“Cloud computing”), optionally with or according to peer-to-peer and/or virtualization technologies. The software code may be executed on any appropriate processor (for example, a microprocessor) or processor core or a set of processors, be they provided in a single calculation device or distributed between several calculation devices (for example such as may possibly be accessible in the environment of the device).

1. A method implemented by computer for the semantic description of the content of an image comprising the steps consisting in:
receiving a signature associated with said image;
receiving a plurality of groups of initial visual concepts;
the method comprising the steps consisting in:
partitioning the groups of initial visual concepts;
expressing the signature of the image in the form of a vector comprising components referring to the partitioned groups of visual concepts;
modifying said signature by applying a filtering rule applicable to the components of said vector.

2. The method as claimed in claim 1, the filtering rule comprising holding or setting to zero one or more components of the vector corresponding to the groups of visual concepts partitioned by applying one or more thresholds.

3. The method as claimed in claim 1, the filtering rule comprising holding or setting to zero one or more components of the vector corresponding to the groups of visual concepts partitioned by applying an order statistic.

4. The method as claimed in claim 1, further comprising a step consisting in determining a selection of partitioned groups of visual concepts and a step consisting in setting to zero the components corresponding to the groups of visual concepts selected.

5. The method as claimed in claim 1, the segmentation into partitioned groups of visual concepts being based on the visual similarity of the images.

6. The method as claimed in claim 1, the segmentation into partitioned groups of visual concepts being based on the semantic similarity of the concepts.

7. The method as claimed in claim 1, the segmentation into partitioned groups of visual concepts being performed by one or more operations chosen from among the use of K-means and/or of hierarchical groupings and/or of expectation maximization and/or of density-based algorithms and/or of connexionist algorithms.

8. The method as claimed in claim 2, at least one threshold being configurable.

9. The method as claimed in claim 1, further comprising a step consisting in receiving and in adding to the semantic description of the content of the image one or more textual annotations of manual source.

10. The method as claimed in claim 1, further comprising a step consisting in receiving at least one parameter associated with an image content based search query, said parameter determining one or more partitioned groups of visual concepts and a step consisting in undertaking the search within the groups of concepts determined.

11. The method as claimed in claim 1, further comprising a step consisting in constructing collections of partitioned groups of visual concepts, a step consisting in receiving at least one parameter associated with an image content based search query, said parameter determining one or more collections from among the collections of partitioned groups of visual concepts and a step consisting in undertaking the search within the collections determined.

12. A computer program product, said computer program comprising code instructions making it possible to perform the steps of the method as claimed in claim 1, when said program is executed on a computer.

13. A system for the implementation of the method as claimed in claim 1.
